(19) United States
(12) Patent Application Publication
(10) Pub. No.: US 2007/0005409 A1
(43) Pub. Date: Jan. 4, 2007

(54) Method and structure for overriding calendar entries based on context and business value

(75) Inventors: Greg Boss, American Fork, UT (US); David Burns, Cary, NC (US); Andrew Richard Jones, Round Rock, TX (US); Kevin C. McConnell, Austin, TX (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/170,441

(22) Filed: Jun. 30, 2005

(51) Int. Cl. G06F 9/46

(52) U.S. Cl. 705/8

(57) ABSTRACT

A method and structure for automatically scheduling a meeting in an electronic calendar system. Calendars of all participants invited to a meeting being scheduled are accessed. Each participant's calendar is checked whether that participant is available for the meeting, in accordance with a priority of the meeting. The meeting is scheduled on each participant's calendar if all said participants are available.

### BACKGROUND OF THE INVENTION

1. Field of the Invention

The present invention generally relates to a system and method for a calendar system. More specifically, calendar events are prioritized and, when conflicts arise, rules based on context and business values can be applied to automate the process of deciding which meetings are more important that others.

2. Description of the Related Art

Busy employees and executives are often fully booked every hour of the day. When urgent business must be conducted, it is difficult to quickly schedule time on individuals' calendars, especially on short notice. For meetings that involve multiple people, even more complication exists in trying to find times mutually available.

Even the process of attempting to prioritize meetings for many people becomes a dauntingly inefficient manual task that adds to the complexities involved. For example, secretaries often “instant message” individuals or call them on the phone to find out if they can skip a meeting in favor of another meeting. This process can be time consuming for all parties involved and result in decreased productivity due to individuals missing meetings or rescheduling calls.

Therefore, it is clear that there exists a need for a system that allows automatic prioritization of calendar events. Moreover, it would be beneficial if such automatic prioritization could make decisions that would result in maximum productivity to all parties involved in a meeting, as well as increasing the efficiency of the process of revising calendars as needs arise.

### SUMMARY OF THE INVENTION

In view of the foregoing, and other, exemplary problems, drawbacks, and disadvantages of the conventional systems, it is an exemplary feature of the present invention to provide a method (and structure) in which events or meetings involving more than one person can be automatically scheduled in accordance with a priority of that event/meeting relative to other events/meetings on participants' schedules.

It is another feature of the present invention to provide an automatic scheduling method that reschedules any event or meeting that is overridden as having a priority lower than that of the event/meeting currently being scheduled.

It is another feature of the present invention to introduce priority parameters into an automatic scheduling function.

It is, therefore, an object of the present invention to provide a method (and structure) for an automatic schedule/reschedule system that automatically schedules an event or meeting with multiple participants in accordance with comparing priority levels of the event/meeting relative to other events/meetings on the participants' calendars.

In a first exemplary aspect of the present invention, to achieve the above features and objects, described herein is a method for automatically scheduling a meeting in an electronic calendar system, including accessing calendars of all participants invited to a meeting begin scheduled; checking, from each of the participant's calendars, whether each participant is available for the meeting, in accordance with a priority of the meeting; and scheduling the meeting on each of the participant's calendar if all the participants are available.

In a second exemplary aspect of the present invention, also described herein is an apparatus including a calendar scheduler that automatically determines whether all participants invited to a meeting are available and accordingly schedules the meeting.

In a third exemplary aspect of the present invention, also described herein is a signal-bearing medium tangibly embodying a program of machine-readable instructions executable by a digital processing apparatus to perform an automatic calendar scheduling function, including a scheduler module that automatically determines whether all participants invited to an event or meeting are available and accordingly schedules the event/meeting.

In a fourth exemplary aspect of the present invention, also described herein is a method for an electronic calendar scheduling service, including electronically providing an entry into a user's electronic calendar scheduler for an event, wherein the entry for the event into the user's electronic calendar scheduler results from accessing a calendar of one or more of participants invited to the event and scheduling the event in accordance with an availability of at least one of the one or more participants, as based on a priority of the event.

Therefore, the present invention provides a solution to the above-mentionioned existing problems for scheduling events and meetings. It will automatically and intelligently schedule and, if necessary, reschedule such events and meetings. It also reduces human intervention time and effort.

Moreover, because the system is based on priorities of the business, meetings for projects that are the most important for the business will be scheduled and/or rescheduled as soon as possible.

These capabilities enable a business to operate faster and more efficiently. Therefore, the present invention also provides a business with a competitive edge.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows a first exemplary flowchart 100 of the steps in setting up a meeting in accordance with concepts of the present invention;

FIG. 2 illustrates a graphical user interface 200 exemplarily used in the prototype of the present invention;

FIG. 3 shows a second exemplary flowchart 300 that illustrates the logic of the priority decisions of the present invention;

FIG. 4 illustrates an exemplary hardware/information handling system 400 for incorporating the present invention therein;

FIG. 5 illustrates a signal bearing medium 500 (e.g., storage medium) for storing steps of a program of a method according to the present invention; and

FIG. 6 illustrates an exemplary block diagram 600 of the aspect of the present invention as being an aggregate of functional modules in an apparatus or software program.

### DETAILED DESCRIPTION OF EXEMPLARY EMBODIMENTS OF THE INVENTION

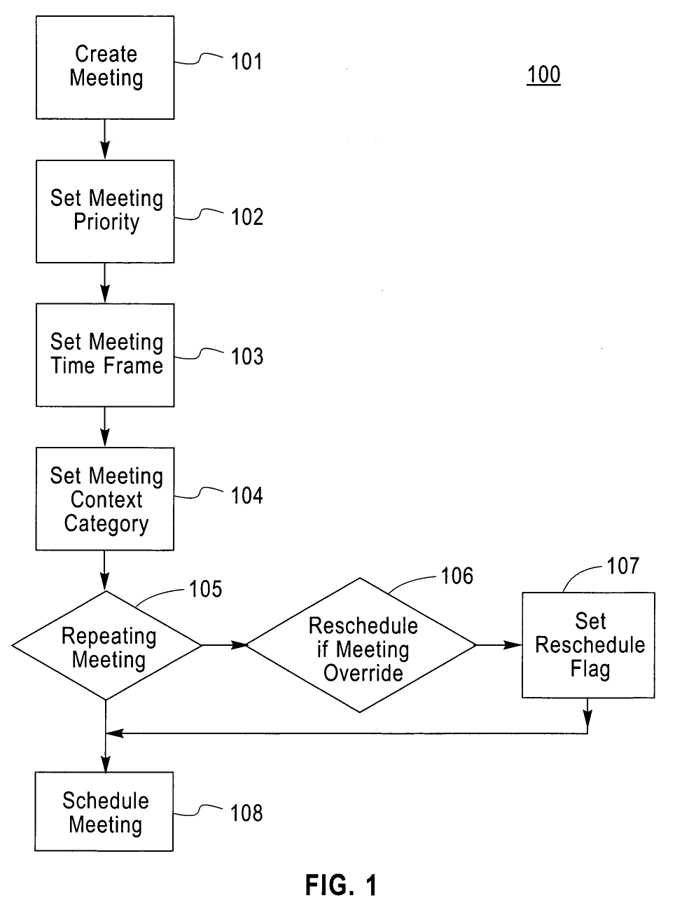

Referring now to the drawings, and more particularly to FIGS. 1-6, preferred embodiments of the method and structures according to the present invention will now be described.

The exemplary embodiments of the present invention demonstrate a system and method to intelligently schedule high priority meetings with individuals that have conflicting schedules. The method can incorporate one or more of the three following elements to determine when a high priority meeting can be scheduled during others' busy time.

The first element is an assigned meeting priority value, which could be either representative or numeric. For example, priority values might be categories, such as: “personal, can't be changed”, “critical”, “important”, “normal”, and “low priority”, or they might be a corresponding numerical listing such as 1, 2, 3, 4, 5.

The second element is the date/time range that the meeting must take place.

The third element is an assigned context or category for the event or meeting. In an exemplary preferred embodiment, the system will contain a database of contexts/projects that are rated in terms related to a “business value” for the business or other entity.

However, it is noted that all three of these elements need not be present. That is, in various embodiments, the present invention still functions in any combination of these three elements, as well as other variations mentioned later.

Operationally, when an individual wishes to initiate a meeting to be scheduled with a set of participants, for example, a high priority meeting, the initiator first identifies who needs to attend and a time frame by which the meeting must occur. For example, a meeting might be required to be completed by 5 PM, Eastern Standard Time.

Having access to all participants' calendars, the system will then first attempt to schedule the meeting during free time, if such free time is determined as being available for all participants. If such free time is not available, the system will then look for low priority meetings that can be rescheduled.

If such available low-priority time is not found, the automatic calendaring scheduler/rescheduler will then systematically check higher-priority current calendar events/meetings against the priority of the present meeting. If an available time still cannot be found, the automatic calendaring scheduler/rescheduler will then check the project name or context and, if the project is of higher value to the business than the other project meetings, would override and schedule the meeting as having higher priority.

If the meeting is successfully scheduled and one or more events or meetings were out-prioritized by scheduling the present meeting, the system then evaluates, in turn, each displaced meeting that needs to be rescheduled and performs rescheduling functions for them.

FIG. 1 shows an exemplary flowchart 100 of the steps in setting up a meeting in accordance with concepts of the present invention. As noted above, in exemplary embodiments, the present invention might include a feature that business projects and meeting context are rated in accordance with a value for prioritization. Therefore, as a preliminary step in such embodiments, a database would be set up that allows each project and meeting context to be given a business value rating.

In step 101, a meeting user begins the process of setting up an event or meeting by entering the “who/what/when/where” information normally used for scheduling. Additional meeting parameters of the present invention might include any or all of the following:

a) Meeting priority 102 (e.g., “can't be changed”, “critical”, “important”, “normal”, and “low”, or 1, 2, 3, 4, 5);

b) Time frame 103 that the meeting must take place;

c) Project name 104 and meeting context category 105, so that a priority can be derived from the database; and

d) If the meeting is a repeating meeting 105, whether it should be rescheduled if overridden 106, 107.

In the prototype model of the present invention, all of the above parameters have been implemented, thereby providing additional flexibility for the scheduling/rescheduling feature that would not be available if one or more parameters from the above listing are not present.

In step 108, the automatic calendar scheduler/rescheduler system proceeds to schedule the meeting.

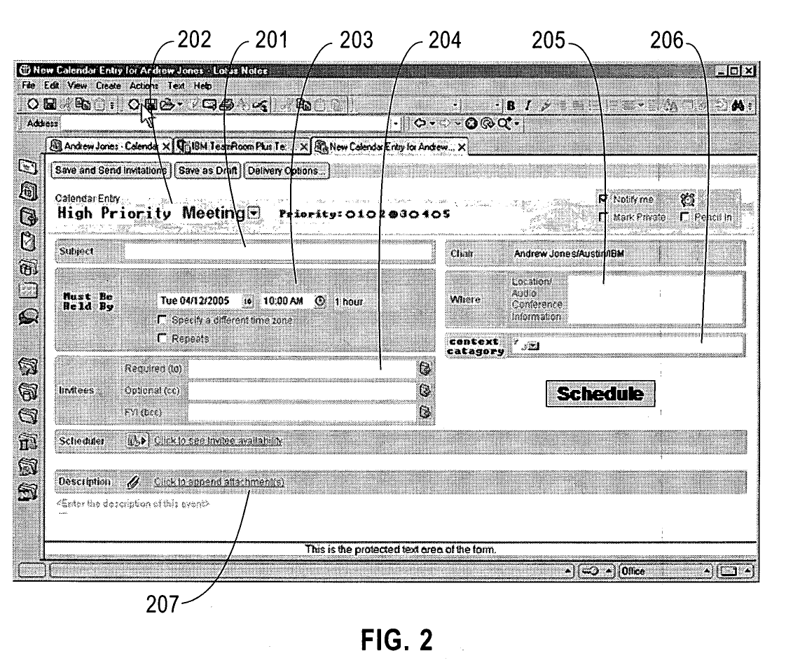

FIG. 2 shows an exemplary graphical user interface (GUI) 200 for the prototype of the present invention. It is noted that this prototype is implemented on an existing calendar platform called “Lotus Notes”™.

In this exemplary GUI, the user enters the subject of the meeting 201, meeting priority category 202, time for completion 203, attendees 204, location 205, context category 206, and attachments 207 for the meeting in the indicated regions of the GUI display.

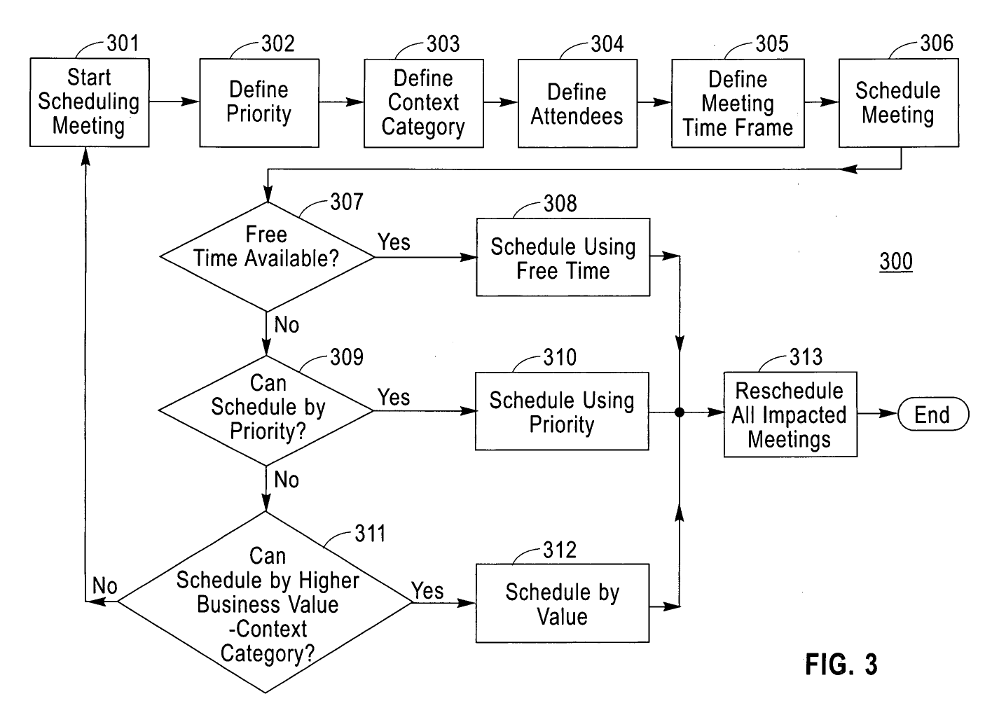

FIG. 3 shows another exemplary flowchart 300 that includes logic of the meeting scheduling/rescheduling process 306, initiated after data has been entered in steps 301-305.

First, in steps 307 and 308, the meeting is attempted to be scheduled based on free time being available for all participants. If no time based on free time is found, then in steps 309 and 310, an attempt is made to schedule the meeting based on priority. The system first looks for low priority meeting that can be overridden. If all participants have lower priority conflicts, the system schedules the meeting as being a higher priority.

If there is no time where lower priority events/meetings can be overridden, the system will sequentially step up one level of priority to find available time and follow the same logic at the next-higher priority level, until the priority level appropriate for the planned meeting has been explored.

If there still is no available time found, in steps 311 and 312, an attempt is made to schedule the meeting, based on business value/context category checking the project business value rating. If the business value of the present meeting is a higher value than the other meetings, the system can override and schedule the present meeting as having higher priority. As one exemplary feature, executives over a specified level can optionally disable the meeting override feature so that none of their meeting can be rescheduled.

If a meeting is scheduled in any of these attempts, all impacted meetings are rescheduled in step 313. Any meeting that has been placed on the calendar as a result of an override can be signified in a manner (e.g., a unique color or font) to assist the calendar owner to understand why their calendar was updated.

If none of the override options work for the meeting requestor, the system will give the meeting requestor the next available time that is found for the meeting, or perhaps provides an alert to the user, returning to step 301 for another scheduling attempt after having one or more parameters changed.

A number of variations of the process above are readily implemented. For example, the scheduler/rescheduler might default to provide the earliest possible time for a meeting with all participants, if no time is entered as a parameter.

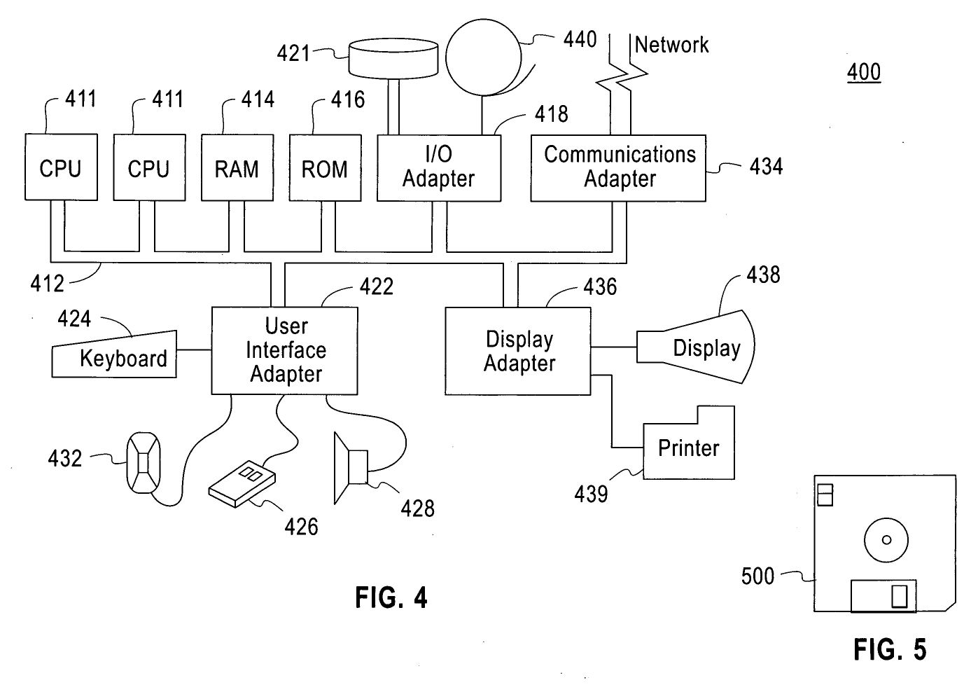

FIG. 4 illustrates a typical hardware configuration of an information handling/computer system in accordance with the invention and which preferably has at least one processor or central processing unit (CPU) 411.

The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, an Intranet, a personal area network (PAN), etc., and a display adapter 436 for connecting the bus 412 to a display device 438 and/or printer 439 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 411 and hardware above, to perform the method of the invention.

This signal-bearing media may include, for example, a RAM contained within the CPU 411, as represented by the fast-access storage for example. Alternatively, the instructions may be contained in another signal-bearing media, such as a magnetic data storage diskette 500 (FIG. 5), directly or indirectly accessible by the CPU 411.

Whether contained in the diskette 500, the computer/CPU 411, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

Along these lines, the present invention can be considered as embodied in either an apparatus, such as a user's desktop or laptop computer executing a software program for a calendar system having the features of the present invention, or as the software product having the software program. Typically, since the meeting participants would be interconnected as members of a group, such as employees in the same company or members of a predefined group, the meeting participant would be interconnected by a communication network of some sort.

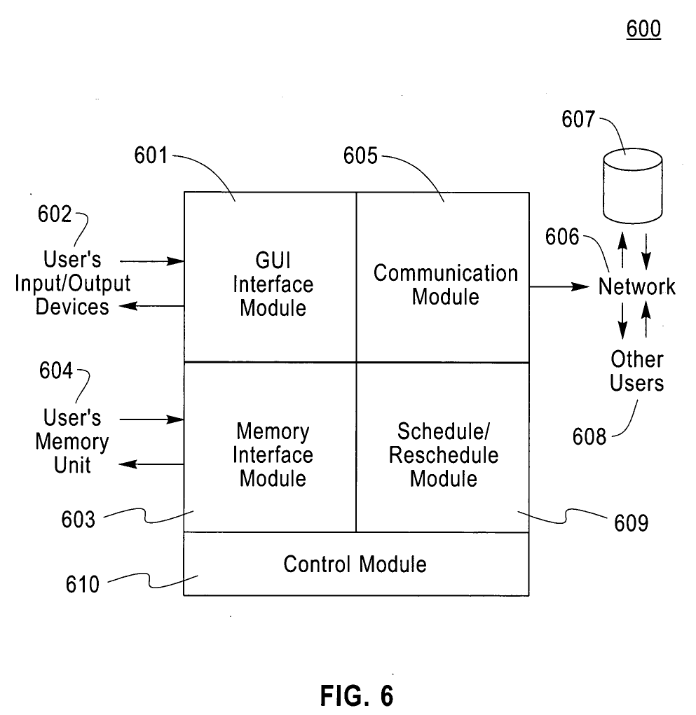

FIG. 6 provides an exemplary block diagram 600 of this definition of the present invention, as being viewed as an apparatus or software program having various modules. GUI interface module 601 provides the interface with the user's computer's input/output devices 602, such as a keyboard, mouse, and monitor.

Memory interface 603 provides the interface to the local memory 604 on the user's computer. Depending upon the specific implementation of the present invention, this local memory would store the instruction modules 601, 603, 605, 609, and 610 that execute the present invention on the user's computer, and may also store a local calendar system into which the present invention is incorporated as a feature therein, as well as the data necessary to execute the present invention on the user's machine.

Communication module 605 provides the interface with a network that interconnects the user's machine to the database 607 that define the priorities for the meetings and to machines of other users listed as participants to the meeting. It is noted that database 607 might be incorporated as part of the local memory unit 604, particularly for smaller entities that use the present invention.

Schedule/reschedule module 609 provides the logic that implements the decisions and scheduling and rescheduling process exemplarily described in FIGS. 1-3.

Although a typical example of the implementation of the present invention would be that each participant's computer stores the calendar system on that individual's computer and each individual's calendar system has the potential of intercommunicating with the calendar system of other participants, there are possible variations.

For example, the company or organization might have a common calendar system in a central location, such as a server, that services the entire group, company, or organization for its specific calendaring functions. In this variation, each individual's computer would be connected to this central location for purpose of determining events or meetings related to that company or organization for which that individual needs to be aware.

A typical interconnection in this variation would be the Internet. It is noted that this variation using a centralized location for a group, company, or organization provides an embodiment of the present invention in which the techniques discussed are implemented in a calendar system that is autonomous to the calendar system commonly installed in each of the participant's computer.

Along this line, the present invention can also provide the basis for a personal scheduling in which events related to a group, business, organizational, or even personal affairs, are coordinated and scheduled based on predetermined priorities for such events. In this variation, the present invention could be part of an existing calendar tool, as adding the feature of event priorities and/or automatic scheduling.

The present invention could also serve as the basis for an electronic calendar scheduling service, in which one or more aspects of the present invention are made available to individuals and/or organizations. In such a service, entries to a user's electronic calendar scheduler might be made for an event, as resulting from accessing a calendar of one or more of participants invited to the event, including the scenario in which only the user's current schedule is accessed, and then scheduling the event in accordance with an availability of one or more potential participants, as based on a predetermined priority of the event.

Thus, it can be seen that the present invention provides a solution to existing problems for scheduling events and meetings. It intelligently schedules and reschedules such events and meetings, while reducing human intervention and time. In exemplary embodiments, the system schedules and, if required, reschedules, as soon as possible, meetings for projects that are the most important for the business. These capabilities enable a business to operate faster, thereby providing a competitive edge.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method of automatically scheduling a meeting in an electronic calendar system, said method comprising:
accessing calendars of all participants invited to a meeting being scheduled;
checking, from each of said participant's calendars, whether each said participant is available for said meeting, in accordance with a priority of said meeting; and
scheduling said meeting on each of said participant's calendar if all said participants are available.

2. The method of claim 1, wherein a meeting initiator enters a time by which said meeting is to be completed and said checking comprises:
determining whether any time prior to said time is available for conducting said meeting by checking whether each said participant is available at some same time prior to said time by which said meeting is to be completed.

3. The method of claim 1, wherein said checking and said scheduling comprises:
determining an earliest time that said meeting can be scheduled.

4. The method of claim 1, wherein at least one of the following parameters are used in executing said automatic scheduling:
an assigned meeting priority value for said meeting;
a date/time range that said meeting must take place;
at least one of an assigned context and category for said meeting.

5. The method of claim 1, wherein said scheduled meeting appears on each said participant's calendar in a manner providing an indication that said scheduled meeting is a change in said calendar.

6. The method of claim 1, further comprising:
determining that said meeting can be scheduled only if at least one other meeting or event is rescheduled for at least one of said participants.

7. The method of claim 6, further comprising:
rescheduling said at least one other meeting or event for said at least one said participant if said meeting has a higher priority.

8. The method of claim 3, wherein said assigned context and/or category are stored in a database of contexts/projects that provide a business value for said meeting.

9. The method of claim 2, further comprising:
if no time prior to said time is found to be available for conducting said meeting, determining an earliest time that said meeting can be scheduled.

10. An apparatus comprising:
a calendar scheduler that automatically determines whether all participants invited to a meeting are available and accordingly schedules said meeting.

11. The apparatus of claim 10, wherein at least one of the following parameters are used for executing said automatic scheduling:
an assigned meeting priority value for said meeting;
a date/time range that said meeting must take place;
at least one of an assigned context and category for said meeting.

12. A signal-bearing medium tangibly embodying a program of machine-readable instructions executable by a digital processing apparatus to perform an automatic calendar scheduling function, said machine-readable instructions comprising:
a scheduler module that automatically determines whether all participants invited to an event or meeting are available and accordingly schedules said event/meeting.

13. The signal-bearing medium of claim 12, wherein said automatic calendar scheduling function is incorporated into a pre-existing calendar system.

14. The signal-bearing medium of claim 12, wherein any changes to a calendar is presented in a manner that highlights said changes to a user.

15. The signal-bearing medium of claim 12, wherein said scheduler module:
accesses a calendar for each of said participants; and
compares a priority of the event/meeting being scheduled with a priority of any conflicting event/meeting on each of said participant's calendar to determine whether said participants are available.

16. The signal-bearing medium of claim 15, wherein said scheduler makes said comparison by sequentially determining, in levels of priority, whether a time is available for all said participants, beginning at a lowest level of priority.

17. The signal-bearing medium of claim 15, wherein said scheduler determines an earliest time that said meeting can occur.

18. The signal-bearing medium of claim 15, further comprising:
if an event or meeting of a participant is overridden because the priority of the event/meeting being scheduled is a higher priority, automatically rescheduling the event or meeting that was overridden.

19. The signal-bearing medium of claim 15, wherein said priority of said event/meeting being scheduled is defined by one or more of the following parameters:
an assigned meeting priority value for said meeting;
a date/time range that said meeting must take place;
at least one of an assigned context and category for said meeting.

20. The signal-bearing medium of claim 12, comprising a program of machine-readable instructions stored on one of a:
standalone diskette intended to be inserted into a computer disk drive unit;
memory unit of a computer for execution by said computer;
a server interconnected to a network so that said machine-readable instructions can be downloaded by a user for execution.

21. A method for an electronic calendar scheduling service, said method comprising:
electronically providing an entry into a user's electronic calendar scheduler for an event, wherein said entry for said event into said user's electronic calendar scheduler results from:
accessing a calendar of one or more of participants invited to said event;
scheduling said event in accordance with an availability of at least one of said one or more participants, as based on a priority of said event.
